(19) United States
(12) Patent Application Publication
(10) Pub. No.: US 2012/0068996 A1
(43) Pub. Date: Mar. 22, 2012

(54) SAFE MODE TRANSITION IN 3D CONTENT RENDERING

(75) Inventors: Alexander Berestov, San Jose, CA (US); Xue Tu, San Jose, CA (US); Xiaoling Wang, San Jose, CA (US); Jianing Wei, San Jose, CA (US)

(73) Assignee: Sony Corporation

(21) Appl. No.: 12/887,425

(22) Filed: Sep. 21, 2010

(51) Int. Cl. G06T 15/00

(52) U.S. Cl. 345/419

(57) ABSTRACT

A method for rendering 3D content in a safe mode includes receiving images to be rendered in a 3D format, and detecting, in the received images, at least one image having a 3D content creation or conversion error that creates an uncomfortable 3D effect to a user. The method may also include transitioning to a safe mode, under which 3D enhancement is performed to the detected at least one image to avoid the uncomfortable 3D effect, and rendering the 3D enhanced image for display.

### TECHNICAL FIELD

The present disclosure relates to methods and systems for rendering three-dimensional (“3D”) content in a safe mode to reduce or avoid uncomfortable or disturbing 3D effects.

### BACKGROUND

Three-dimensional TV has been foreseen as a part of a next wave of promising technologies for consumer electronics. Also, 3D digital photo frames and other 3D rendering applications are gaining popularity among consumers. Nevertheless, the lack of quality 3D content in the market has attracted much attention. There exist many conventional methods and systems for obtaining 3D content using 3D image capturing devices. There also exist many conventional methods and systems for creating 3D content from existing two-dimensional (“2D”) content sources using 2D-to-3D conversion technologies. Existing technologies, however, are deficient in that the resulting 3D content contains uncomfortable or disturbing 3D effects. This sub-quality 3D content frequently results from an error in the creation or conversion process.

Thus, there is a need to develop methods and systems that can detect the 3D content creation or conversion error and render the 3D content in a “safe mode” that reduces or avoids uncomfortable or disturbing 3D effects caused by the error.

### SUMMARY

The present disclosure includes an exemplary method for rendering 3D content in a safe mode. Embodiments of the method include receiving images to be rendered in a 3D format, and detecting, in the received images, at least one image having a 3D content creation or conversion error that creates an uncomfortable 3D effect to a user. Embodiments of the method may also include transitioning to a safe mode, under which 3D enhancement is performed to the detected at least one image to avoid the uncomfortable 3D effect, and rendering the 3D enhanced image for display.

An exemplary system in accordance with the present disclosure comprises a user device configured to receive images to be rendered in a 3D format, and a safe mode module coupled to the user device. The safe mode module is configured to detect, in the received images, at least one image having a 3D content creation or conversion error that creates an uncomfortable 3D effect to a user. In some embodiments, the safe mode module is also configured to transition to a safe mode, under which 3D enhancement is performed to the detected at least one image to avoid the uncomfortable 3D effect, and render the 3D enhanced image to the user device for display.

It is to be understood that both the foregoing general description and the following detailed description are exemplary and explanatory only and are not restrictive of the invention, as claimed.

### BRIEF DESCRIPTION OF THE DRAWINGS

FIG. 1 illustrates a block diagram of an exemplary system consistent with the presently-claimed invention.

FIG. 2 is a flow chart illustrating an exemplary embodiment for rendering 3D content in a safe mode.

FIG. 3A illustrates an exemplary 2D image.

FIG. 3B illustrates exemplary 3D enhancement to the image of FIG. 3A in a safe mode.

FIG. 3C illustrates additional exemplary 3D enhancement to the image of FIG. 3B in a safe mode.

FIG. 4A illustrates an exemplary 2D indoor scene image.

FIG. 4B illustrates an exemplary sphere depth map of an indoor scene image in FIG. 4A in a safe mode.

FIG. 4C illustrates exemplary 3D enhancement to an indoor scene image in FIG. 4A in a safe mode.

FIG. 5 is a block diagram illustrating one exemplary embodiment of a safe mode module 106 in the exemplary system 100 of FIG. 1.

### DETAILED DESCRIPTION

Reference will now be made in detail to the exemplary embodiments illustrated in the accompanying drawings. Wherever possible, the same reference numbers will be used throughout the drawings to refer to the same or like parts.

Methods and systems disclosed herein have many practical applications. For example, exemplary embodiments may be used in 3D TV, 3D digital photo frames, and any other 3D rendering applications for rendering 3D content in a safe mode.

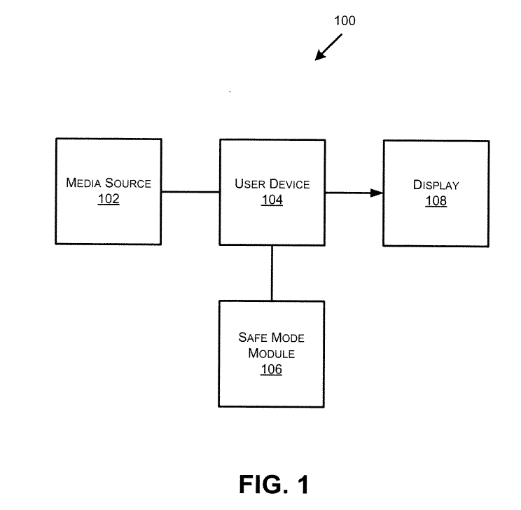

FIG. 1 illustrates a block diagram of an exemplary system 100 consistent with the presently-claimed invention. As shown in FIG. 1, exemplary system 100 may comprise a media source 102, a user device 104, a safe mode module 106, and a display 108, operatively connected to one another via a network or any type of communication links that allow transmission of data from one component to another. The network may include Local Area Networks (LANs) and/or Wide Area Networks (WANs), and may be wireless, wired, or a combination thereof.

Media source 102 can be any type of storage medium capable of storing visual content, such as video or still images. For example, media source 102 can be provided as a video CD, DVD, Blu-ray disc, hard disk, magnetic tape, flash memory card/drive, volatile or non-volatile memory, holographic data storage, and any other type of storage medium. Media source 102 can also be an image capturing device or computer capable of providing visual content to user device 104. For example, media source 102 can be a camera capturing imaging data in 2D or 3D format and providing the captured imaging data to user device 104. For another example, media source 102 can be a web server, an enterprise server, or any other type of computer server. Media source 102 can be a computer programmed to accept requests (e.g., HTTP, or other protocols that can initiate a media session) from user device 104 and to serve user device 104 with visual content. In addition, media source 102 can be a broadcasting facility, such as free-to-air, cable, satellite, and other broadcasting facility, for distributing visual content. Further, in certain embodiments, media source 102 can include a 2D-to-3D content converter (not shown) for converting 2D visual content into 3D content, if the content is not obtained or received in 3D format.

User device 104 can be, for example, a computer, a personal digital assistant (PDA), a cell phone or smartphone, a laptop, a desktop, a video content player, a set-top box, a television set including a broadcast tuner, a video game controller, or any electronic device capable of providing or rendering visual content. User device 104 may include software applications that allow user device 104 to communicate with and receive visual content from a network or local storage medium. In some embodiments, user device 104 can receive visual content from a web server, an enterprise server, or any other type of computer server through a network. In other embodiments, user device 104 can receive content from a broadcasting facility, such as free-to-air, cable, satellite, and other broadcasting facility, for distributing the content through a data network. In certain embodiments, user device 104 may comprise a 2D-to-3D content converter for converting 2D visual content into 3D content, if the content is not received in 3D format.

Safe mode module 106 can be implemented as a software program and/or hardware that performs safe mode transition in 3D content rendering. Safe mode module 106 can detect 3D content creation or conversion errors in the received visual content, and switch to a safe mode. In the safe mode, safe mode module 106 can perform 3D enhancement to the content to reduce or avoid uncomfortable or disturbing 3D effects. Safe mode module 106 renders the enhanced content for display. In some embodiments, safe mode transition can be part of 2D-to-3D content conversion. Safe mode transition will be further described below.

Display 108 is a display device. Display 108 may be, for example, a television, monitor, projector, display panel, and any other display device.

While shown in FIG. 1 as separate components that are operatively connected, any or all of media source 102, user device 104, safe mode module 106, and display 108 may be co-located in one device. For example, media source 102 can be located within or form part of user device 104, safe mode module 106 can be located within or form part of media source 102, user device 104, or display 108, and display 108 can be located within or form part of user device 108. It is understood that the configuration shown in FIG. 1 is for illustrative purposes only. Certain devices may be removed or combined and other devices may be added.

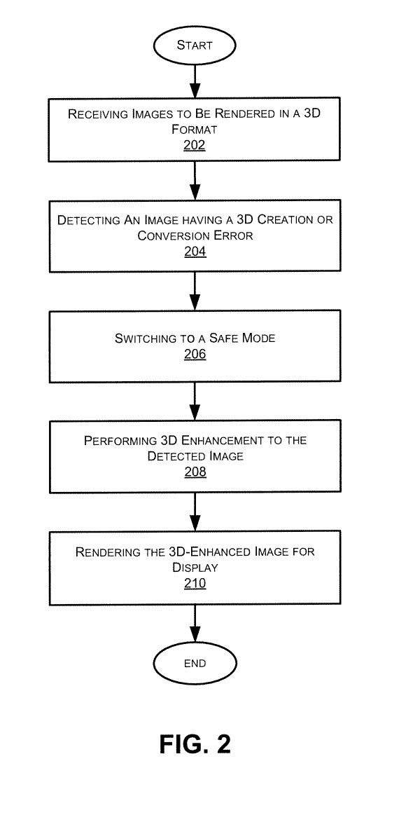

FIG. 2 is a flow chart illustrating an exemplary method for rendering 3D content in a safe mode. As shown in FIG. 2, images (e.g., still images or video frames) to be rendered in a 3D format are received (step 202). The received images may either be 3D image data recorded using a 3D capturing device, or the images may be 3D images created based on images captured in a 2D format. Three-dimensional images may be created from 2D image data by, for example, constructing depth information for corresponding left and right images. During a 2D-to-3D conversion process, objects in a 2D image may be analyzed and segmented into different categories, e.g., foreground and background objects, and a depth map may be generated based on the segmented objects. Conversion from 2D-to-3D may take place on stored images or on the fly as the images are received.

Three-dimensional images, whether originally captured in a 3D format or converted from a 2D image, comprise corresponding left and right images. The left and right images can be used to create an illusion of a 3D scene or object by controlling how the images are displayed to each of the viewer's eyes. In some cases, 3D eyewear may be used to control how the images are displayed to each of a viewer's eyes. If a viewer's left and right eyes observe different images where a same object sits at different locations on a display screen, the user's brain can create an illusion as if the object were in front of or behind the display screen.

Referring back to FIG. 2, in step 204, received images having 3D creation or conversion errors are detected. In some embodiments, for example, images with errors are detected by comparing the depth map value of the received or converted 3D image to one or more predefined thresholds. If the comparison determines that the depth map of the 3D image is not smooth or is irregular, displaying the 3D image may create uncomfortable or disturbing 3D effects. The smoothness or regularity can be calculated through some measurements, and different applications may have different measurements. For example, one criterion to calculate the smoothness is to calculate a depth gradient. If a mean value of the depth gradient is over a predefined threshold or outside a predefined range, then the depth map is considered as not smooth. For another example, a landscape image may contain a ground region that is usually located at a bottom part of the image and appears closer to an observer. If the depth map of the landscape image appears in a reverse way, then it can be considered as irregular. For further example, at an image analysis stage of a 2D-to-3D conversion process, if an image is over-segmented, e.g., being segmented into many (e.g., 1000) small pieces rather than several big pieces labeled with a semantic meaning (e.g., sky, ground, tree, rocks, etc.), then the analysis result can be considered as irregular, and the image rendering process stops the depth map generation stage and goes directly to a safe mode. In practice, multiple measurements can be weighted in combination or individually, based on different applications.

In some embodiments, an estimated structure of an image scene may be checked to determine whether the 3D images follow one or more pre-configured rules or common criteria derived from observations in our daily lives, such as, e.g., the sky is above the ground and trees, and buildings stand on the ground, etc. For example, as described above, at an image analysis stage, an image can be segmented into several pieces and each piece can be labeled with a semantic meaning, then automatically each piece's position can be known. If the sky appears below the ground, then the analysis result can be considered as invalid, and a 3D content creation or conversion error occurs. In some embodiments, the one or more pre-configured rules or common criteria can be carried out in combination or individually to detect a 3D content creation or conversion error. In other embodiments, creation or conversion errors may be detected during 2D-to-3D conversion, for example, if objects in a 2D image cannot be classified into certain categories or be labeled with certain semantic meanings.

Once a 3D content creation or conversion error is detected in an image, the image rendering mode can be automatically switched or transitioned to a safe mode (step 206). In some embodiments, a user may be provided with an option to manually turn the rendering mode to the safe mode when he/she feels uncomfortable about 3D effects of the received images. In the safe mode, 3D enhancement can be automatically performed to the detected image (step 208). The detected image may be in a 3D format or in a 2D format being converted into a 3D format. If the detected image is in a 3D format, it may include same or different left and right 2D images, as described above. The 3D enhancement can be based on the 2D image of the detected image. If the detected image is in a 3D format, one of the left and right images can be extracted or acquired from the 3D image, and the 3D enhancement can be based on the extracted image. If the detected image is in a 2D format and is still undergoing a 2D-to-3D conversion process, the 3D enhancement can be based on the 2D image, and the converted 3D image having the conversion error can be discarded.

In some embodiments, 3D enhancement may be performed, for example, by shifting pixels in one of the corresponding 2D images in relation to the other corresponding 2D image based on a predefined depth map. Such a depth map can be of a constant value for every pixel, a concave spherical depth map, or any other types of maps (e.g., an inclined flat depth map, a parabola depth map, a cylindrical depth map, etc.). The system can store several different types of depth maps in a database, and using which type of depth map for an individual image can be predefined, decided by an image analysis result, or configured or chosen by a user.

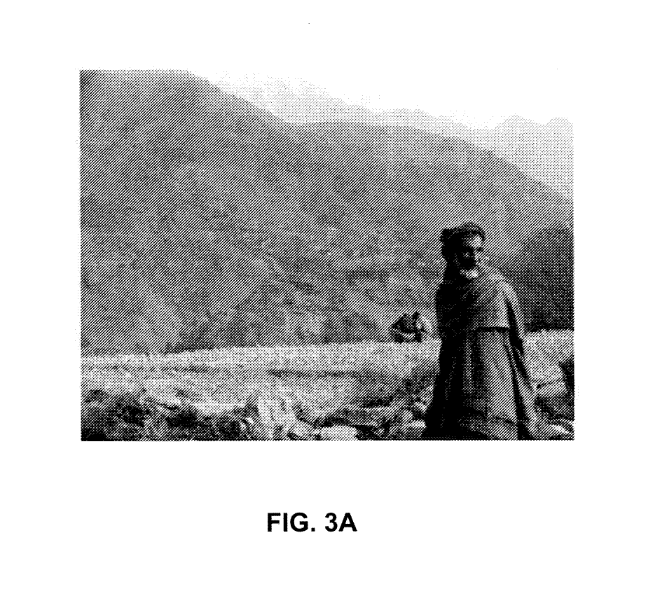

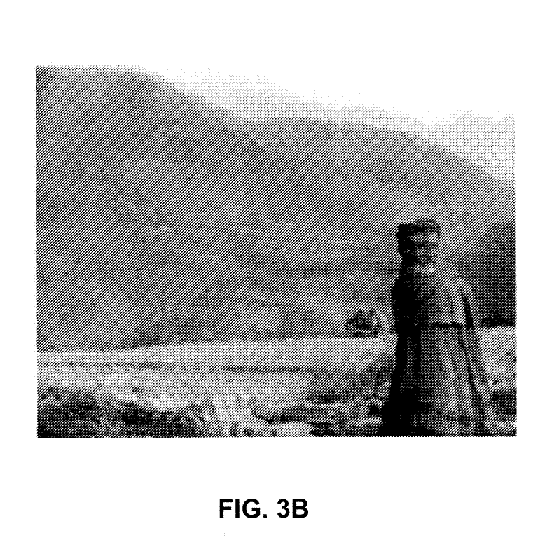

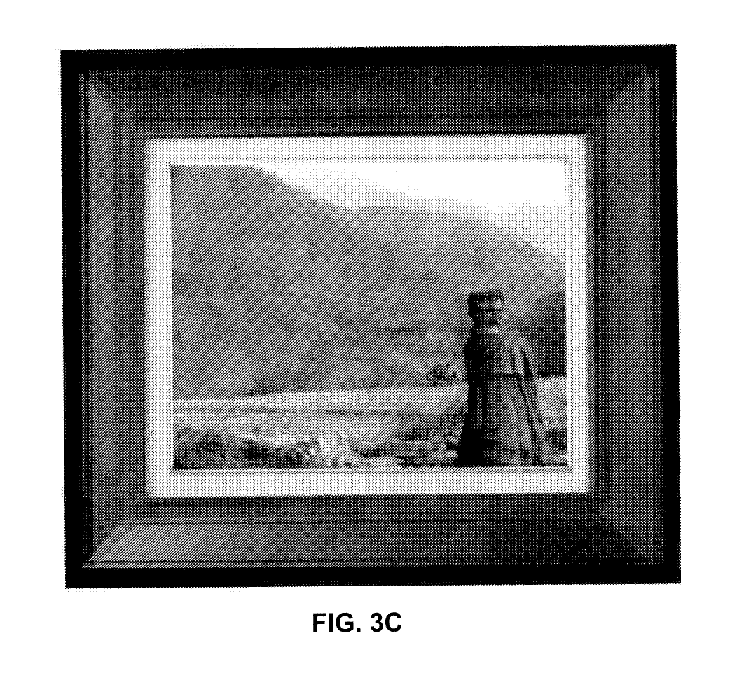

For example, in some embodiments, the 3D enhancement may be performed by shifting pixels in a 2D image based on a depth map with a constant value for every pixel. FIG. 3A illustrates an exemplary 2D image, and FIG. 3B illustrates the image of FIG. 3A after 3D enhancement based on a depth map with a constant value for every pixel. By shifting one or more of the 2D images in FIG. 3A in relation to each other, a depth effect can be created, and a user's brain can create an illusion that the objects in the image stand behind a display screen, as shown in FIG. 3B. The distance between the left image and the right image may be created by shifting one image, and not the other, or shifting both images to some degree. The shift distance may either be pre-defined or be determined empirically. In some embodiments, the user may be provided with an option to manually adjust or configure the shifting distance.

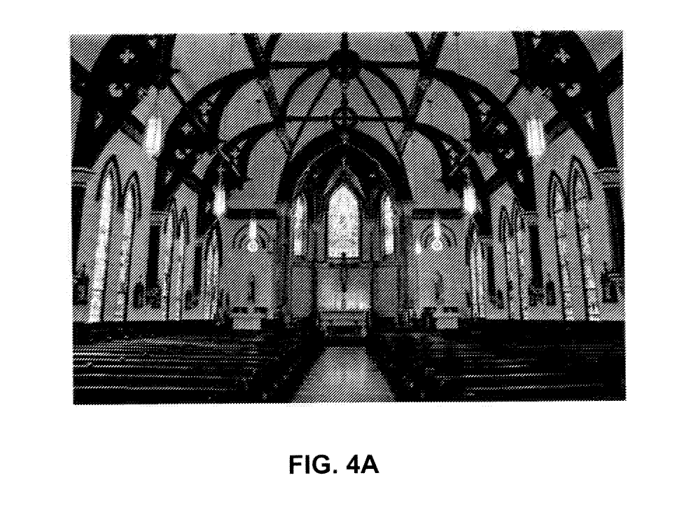

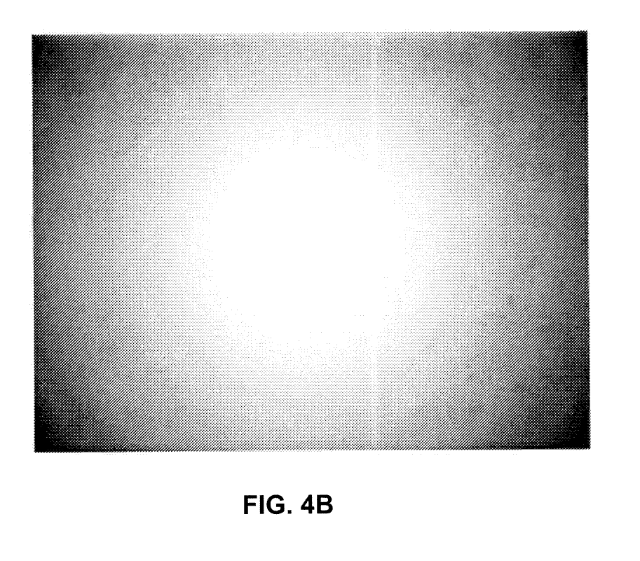

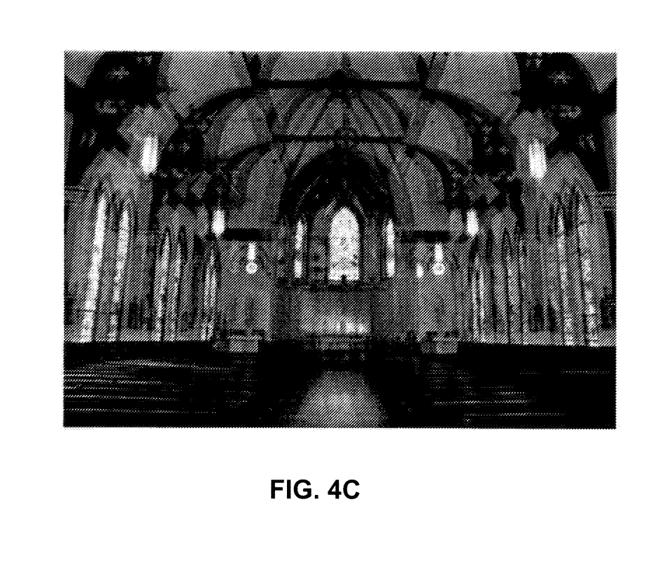

For another example, in some embodiments, the 3D enhancement may be performed by shifting pixels in a 2D image based on a depth map corresponding to a structure of the 2D image. For example, if image analysis of a 2D-to-3D conversion process indicates that the input image is of an indoor scene and the system fails to generate a meaningful depth map, then the 3D enhancement can be based on a spherical, or a cylindrical, or a parabolic depth map, as most indoor scenes have a concave structure. For example, FIG. 4A illustrates an exemplary 2D indoor scene image, which can be mapped to a concave sphere to generate a concave sphere depth map in a safe mode as illustrated in FIG. 4B. In some embodiments, the concave sphere depth map can be predefined and provided. In the concave sphere depth map, the dark color indicates nearby or close objects and the bright color indicates distant objects. Each pixel in the 2D indoor scene image can be shifted to left or right with a distance based on, for example, a corresponding pixel in the concave sphere depth map. Different pixels in the 2D indoor scene image may be shifted with different distances corresponding to the concave sphere depth map. The resulting indoor scene image with the 3D enhancement can have vivid 3D effects, as illustrated in, for example, FIG. 4C, which illustrates exemplary 3D enhancement to the indoor scene image in the safe mode. In some embodiments, a user may be provided with an option to turn the rendering mode to the safe mode when he/she feels uncomfortable and to manually adjust or configure the shifting distance.

In some embodiments, the 3D enhancement can be, for example, adding to the 2D image or the 3D enhanced image one or more 3D objects or objects with 3D effects and thus creating 3D illusions or effects. A 3D object or an object with 3D effects can be, for example, a 3D photo frame, a 3D flower, a 3D caption, a 3D ribbon, and etc. For example, FIG. 3C illustrates additional exemplary 3D enhancement to the image of FIG. 3B in a safe mode. As illustrated in FIG. 3C, a 3D photo frame can be added to the 3D enhanced image of FIG. 3B and make the image stay inside the frame. Also, pixels of the 3D object (e.g., the 3D photo frame) can be shifted based on a depth map or a 3D shape of the 3D object. In some embodiments, along with the 3D object, its depth map or 3D model may also be provided, so the pixel shifting can be based on the depth map. Nevertheless, the depth map may indicate relative depth information. For example, if 0 in the depth map indicates a closest depth value and 255 in the depth map indicates a farthest depth value, then the 3D enhanced image can be rendered with a depth range of 0˜255, 100˜355, or −100˜155 based on actual applications. For example, in a context of 3D image rendering, if a depth of a display screen is marked as 0, then the depth of the 3D image can be set with positive values such that the 3D image appears behind the display screen and extending to a distant place. In the meantime, the depth of the 3D object can be set in a negative range such that the 3D object appears floating in front of the display screen. If the depth of the 3D object is of a negative value, the pixels of the 3D object are shifted in an opposite direction from the above described image shifting direction to create such a floating effect. Placing a 3D object floating in front of the display screen can make the image look deeper and the overall visual effect more interesting.

The 3D object shifting distance may be pre-defined and can be determined empirically. In some embodiments, the user may be provided with an option to manually select one or more 3D objects for 3D enhancement and to manually adjust or configure the 3D object's shifting distance.

The above described methods for 3D enhancement may not recover a true 3D structure and/or may not correct the 3D content creation or conversion error. Nevertheless, these methods can create 3D effects or illusions for human and reduce or avoid visual discomfort caused by the error.

Referring back to FIG. 2, after the 3D enhancement has been done to the detected image having a 3D content creation or conversion error, the 3D enhanced image is rendered for display (step 210). The method then ends.

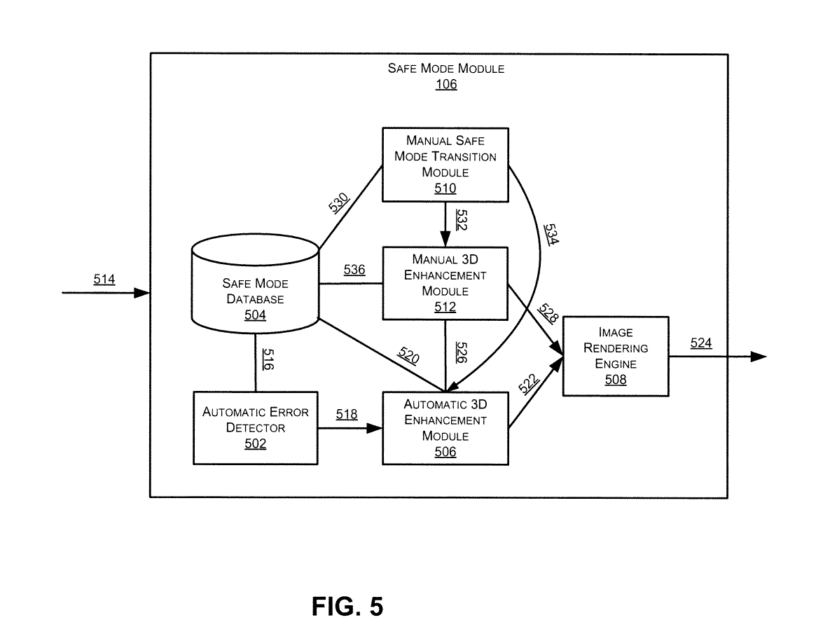

FIG. 5 is a block diagram illustrating one exemplary embodiment of a safe mode module 106 in the exemplary system 100 of FIG. 1. As shown in FIG. 5, safe mode module 106 may include an automatic error detector 502, a safe mode database 504, an automatic 3D enhancement module 506, an image rendering engine 508, a manual safe mode transition module 510, and a manual 3D enhancement module 512.

It is understood that components of safe mode module 106 shown in FIG. 5 are for illustrative purposes only. Certain components may be removed or combined and other components may be added. Also, one or more of the components depicted in FIG. 5 may be implemented in software on one or more computing systems. For example, they may comprise one or more applications, which may comprise one or more computer units of computer-readable instructions which, when executed by a processor, cause a computer to perform steps of a method. Computer-readable instructions may be stored on a tangible computer-readable medium, such as a memory or disk. Alternatively, one or more of the components depicted in FIG. 5 may be hardware components or combinations of hardware and software such as, for example, special purpose computers or general purpose computers.

With reference to FIG. 5, safe mode module 106 receives images, e.g., still images or video frames (step 514). Based on the above described criteria or thresholds acquired from, for example, safe mode database (step 516), automatic error detector 502 can determine and detect a 3D content creation or conversion error in one of the received images, as described above. In some embodiments, automatic error detector 502 may store the detected error and/or image in safe mode database 504 (step 516), or pass the detected error and/or image to automatic 3D enhancement module 506 (step 518).

Safe mode database 504 can be used for storing a collection of data related to safe mode transition in 3D content rendering. The storage can be organized as a set of queues, a structured file, a relational database, an object-oriented database, or any other appropriate database. Computer software, such as a database management system, may be utilized to manage and provide access to the data stored in safe mode database 504. Safe mode database 504 may store, among other things, predefined criteria or thresholds for determining 3D content creation or conversion failures or errors creating or causing uncomfortable/disturbing 3D effects, and 3D enhancement configuration information. The 3D enhancement configuration information may include but is not limited to, for example, predefined depth maps used for shifting image pixels for 3D enhancement, 3D objects for 3D enhancement, depth maps associated with the 3D objects and for shifting pixels of the 3D objects for 3D enhancement, and other information for 3D enhancement to reduce or avoid uncomfortable/disturbing 3D effects caused by 3D content creation or conversion errors. In some embodiments, safe mode database 504 may store detected errors and detected images having the errors.

In some embodiments, automatic 3D enhancement module 506 can utilize the 3D enhancement configuration information to automatically perform 3D enhancement to the detected image, as described above. The 3D enhancement configuration information can be acquired from, for example, safe mode database 504 (step 520). Automatic 3D enhancement module 506 can forward (step 522) the 3D enhanced image to image rendering engine 508, which can render the 3D enhanced image for display (step 524). In some embodiments, manual 3D enhancement module 512 may be employed to provide a user interface for a user to manually adjust or configure the 3D enhancement (step 526), as described above. The image with manually adjusted or configured 3D enhancement is passed to image rendering engine 508 for display (steps 528 and 524).

In some embodiments, manual safe mode transition module 510 can be employed to provide a user interface for a user to manually turn the rendering mode to the safe mode when he/she feels uncomfortable or disturbing about 3D effects of some of the received images. Also, manual safe mode transition module 510 can provide a user interface for the user to manually define or configure 3D content creation or conversion errors. The manually defined or configured errors and its configuration information can be stored in safe mode database 504 (step 532) for later detecting a similar or same error in future received images.

In the manual safe mode, the images having the uncomfortable or disturbing 3D effects are then passed to manual 3D enhancement module 512 or automatic 3D enhancement module 506 for performing the above described 3D enhancement to those images (steps 532 and 534). In some embodiments, the user has an option to utilize manual 3D enhancement module 512 to acquire the 3D enhancement configuration information from, for example, safe mode database 504 (step 536), and then manually adjust or configure the 3D enhancement performed to those images, as described above. In some embodiments, once the user manually turns on the safe mode, automatic 3D enhancement module 506 can automatically perform 3D enhancement to those images, as described above. The 3D enhanced images are forwarded to image rendering engine for display (steps 522, 528, and 524).

During the above described safe mode transition process, each component of safe mode module 106 may store its computation/determination results in safe mode database 504 for later retrieval or training purpose. Based on the historic data, safe mode module 106 may train itself for improved performance on detecting 3D content creation or conversion errors and performing 3D enhancement.

The methods disclosed herein may be implemented as a computer program product, i.e., a computer program tangibly embodied in an information carrier, e.g., in a machine readable storage device, or a tangible computer readable medium, for execution by, or to control the operation of, data processing apparatus, e.g., a programmable processor, a computer, or multiple computers. A computer program can be written in any form of programming language, including compiled or interpreted languages, and it can be deployed in any form, including as a standalone program or as a module, component, subroutine, or other unit suitable for use in a computing environment. A computer program can be deployed to be executed on one computer or on multiple computers at one site or distributed across multiple sites and interconnected by a communication network.

A portion or all of the methods disclosed herein may also be implemented by an application specific integrated circuit (ASIC), a field-programmable gate array (FPGA), a complex programmable logic device (CPLD), a printed circuit board (PCB), a digital signal processor (DSP), a combination of programmable logic components and programmable interconnects, a single central processing unit (CPU) chip, a CPU chip combined on a motherboard, a general purpose computer, or any other combination of devices or modules capable of performing safe mode transition disclosed herein.

In the preceding specification, the invention has been described with reference to specific exemplary embodiments. It will, however, be evident that various modifications and changes may be made without departing from the broader spirit and scope of the invention as set forth in the claims that follow. The specification and drawings are accordingly to be regarded as illustrative rather than restrictive. Other embodiments of the invention may be apparent to those skilled in the art from consideration of the specification and practice of the invention disclosed herein.

What is claimed is:

1. A computer-implemented method comprising:
receiving images to be rendered in a 3D format;
detecting, in the received images, at least one image having a 3D content creation or conversion error that creates an uncomfortable 3D effect to a user;
transitioning to a safe mode, under which 3D enhancement is performed to the detected at least one image to avoid the uncomfortable 3D effect; and
rendering the 3D enhanced image for display.

2. The method of claim 1, wherein the received images are still images or video frames.

3. The method of claim 1, wherein detecting the at least one image is performed automatically or manually by the user.

4. The method of claim 1, wherein detecting the at least one image comprises:
analyzing the at least one image based on predefined criteria; and
determining whether the at least one image has the 3D content creation or conversion error based on the analysis.

5. The method of claim 1, wherein transitioning to a safe mode is performed automatically or manually by the user.

6. The method of claim 1, wherein the 3D enhancement is performed automatically or manually by the user.

7. The method of claim 1, wherein the 3D enhancement comprises:
shifting pixels in one copy of a 2D image apart from another copy of the 2D image to create a 3D effect, the 2D image being acquired from the detected at least one image.

8. The method of claim 7, wherein shifting pixels is based on a predefined depth map.

9. The method of claim 1, wherein the 3D enhancement comprises:
adding a 3D object to the detected at least one image; and
shifting pixels of the 3D object to create a 3D effect based on a depth map associated with the 3D object.

10. An apparatus coupled to receive images to be rendered in a 3D format, the apparatus comprising:
an error detector to detect, in the received images, at least one image having a 3D content creation or conversion error that creates an uncomfortable 3D effect to a user, and to transition to a safe mode;
a 3D enhancement module to perform, in the safe mode, 3D enhancement to the detected at least one image to avoid the uncomfortable 3D effect; and
an image rendering engine to render the 3D enhanced image for display.

11. The apparatus of claim 10, the error detector is further configured to:
analyze the at least one image based on predefined criteria; and
determine whether the at least one image has the 3D content creation or conversion error based on the analysis.

12. The apparatus of claim 10, the 3D enhancement module is further configured to perform the 3D enhancement by shifting pixels in one copy of a 2D image apart from another copy of the 2D image to create a 3D effect, the 2D image being acquired from the detected at least one image.

13. The apparatus of claim 12, the 3D enhancement module is further configured to perform the 3D enhancement by shifting the pixels based on a predefined depth map.

14. The apparatus of claim 10, the 3D enhancement module is further configured to perform the 3D enhancement by:
adding a 3D object to the detected at least one image; and
shifting pixels of the 3D object to create a 3D effect based on a depth map associated with the 3D object.

15. The apparatus of claim 10, further comprising:
a manual safe mode transition module to provide a user interface for the user to manually turn on the safe mode.

16. The apparatus of claim 15, wherein the manual safe mode transition module is further configured to:
provide a user interface for the user to manually define the 3D content creation or conversion error.

17. The apparatus of claim 10, further comprising:
a manual 3D enhancement module to provide a user interface for the user to manually configure the 3D enhancement performed to the detected at least one image.

18. A system comprising:
a user device configured to receive images to be rendered in a 3D format; and
a safe mode module coupled to the user device and configured to
detect, in the received images, at least one image having a 3D content creation or conversion error that creates an uncomfortable 3D effect to a user;
transition to a safe mode, under which 3D enhancement is performed to the detected at least one image to avoid the uncomfortable 3D effect; and
render the 3D enhanced image to the user device for display.

19. The system of claim 18, wherein the user device and the safe mode module are housed within a same device.

20. A computer-readable medium storing instructions that, when executed, cause a computer to perform a method, the method comprising:
receiving images to be rendered in a 3D format;
detecting, in the received images, at least one image having a 3D content creation or conversion error that creates an uncomfortable 3D effect to a user;
transitioning to a safe mode, under which 3D enhancement is performed to the detected at least one image to avoid the uncomfortable 3D effect; and
rendering the 3D enhanced image for display.
